(19) United States
(12) Patent Application Publication
(10) Pub. No.: US 2010/0307882 A1
(43) Pub. Date: Dec. 9, 2010

(54) GEARBOX DEVICE

(76) Inventors: Andre Ullrich, Filderstadt-Bernhausen (DE); Thomas Bernhardt, Aichtal-Groetzingen (DE); Tobias Herr, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/528,613

(22) PCT Filed: Jan. 30, 2008
(86) PCT No.: PCT/EP2008/051105

§ 371 Date: Aug. 25, 2009

(30) Foreign Application Priority Data
Mar. 2, 2007 (DE) 10 2007 010 182.3

(51) Int. Cl. F16D 7/04

(52) U.S. Cl. 192/20

(57) ABSTRACT

The invention relates to a gearbox device, in particular for a hammer drill or chisel, which includes a drive mechanism and an overload clutch arranged on the drive mechanism. The overload clutch has a spring element, a toothed gear unit, and a locking element. According to the invention, the spring element is arranged along a force flow direction of the drive mechanism on the drive mechanism before the toothed gear unit and the locking element.

### PRIOR ART

The invention is based on a transmission device with the defining characteristics of the preamble to claim 1.

There is already a known transmission device that includes an output means and an overload clutch situated on the output means. The overload clutch in it has a spring element, a gear unit, and a detent element.

### ADVANTAGES OF THE INVENTION

The invention is based on a transmission device, in particular for a rotary hammer and/or a chisel hammer, having an output means and an overload clutch that is situated on the output means and is equipped with a spring element, a gear unit, and a detent element.

In one proposed embodiment, the spring element is situated on the output means, before the gear unit and the detent element along a force flow direction of the output means. In this connection, the expression “along a force flow direction” is understood in particular to mean a direction in which a force is transmitted along the output means to a tool and which extends along a longitudinal axis of the output means toward a tool holder. The term “overload clutch” is understood here to mean a clutch that determines a maximum torque to be transmitted to a tool and, via the tool, to an item to be machined. The gear unit is preferably provided to transmit a torque to the output means. In one embodiment according to the invention, a particularly short and compact transmission device can be achieved, which, in particular through the arrangement of the gear unit after the spring element along the force flow direction, is able to create an additional space that is provided, for example, for a switching between different transmission stages in order to transmit different torques. Preferably, the output means is constituted by a rotating output means, in particular such as a hammer tube of a rotary hammer and/or chisel hammer.

If the gear unit is situated on the output means, before the detent element along the force flow direction of the output means, then it is possible to achieve a structurally simple, component-saving overload clutch in that the gear unit can be supported against the detent element in the force flow direction.

According to another proposed embodiment, the gear unit has at least two torque-transmitting regions for transmitting different drive speeds to the output means. This makes it possible to achieve a particularly space-saving arrangement of the transmission device in that in addition to an overload function, the overload clutch is simultaneously provided to transmit different torques to the hammer tube. Preferably, the two torque-transmitting regions are each composed of a gear.

According to another proposed embodiment, the gear unit has at least one force-transmitting element that is provided for coupling to the detent element, which makes it possible to achieve an at least partially co-rotational and in particular, direct arrangement and coupling of the gear unit to the detent element. A reduction in components, space, assembly complexity, and costs can advantageously be achieved if the gear unit is embodied of one piece with the force-transmitting element.

According to another proposed embodiment, the force-transmitting element has a trapezoidal transverse profile, making it possible to achieve a uniform distribution of a force along a trapezoidal leg. Preferably, the gear unit has a plurality of trapezoidal force-transmitting elements, with the individual force-transmitting elements advantageously arranged spaced uniformly apart from one another in a circumference direction. In principle, however, it is also entirely conceivable for an alternative embodiment of the invention to have any other transverse profile deemed appropriate by those skilled in the art.

If the detent element is also coupled to the output means for co-rotation, then it is advantageously possible to achieve a structurally simple torque transmission from the gear unit via the detent element to the output means. Furthermore, in an additional embodiment of the invention, a further reduction in the number of components, amount of space, assembly complexity, and costs can be achieved if the detent element is embodied of one piece with the output means.

According to another proposed embodiment of the invention, the gear unit is composed of a sintered component, permitting a particularly inexpensive manufacture of the gear unit. In this case, it is in particular possible to eliminate a complex, expensive finishing of the gear manufactured by means of a sintering process. It is fundamentally also conceivable to manufacture the gear unit by means of an extrusion press method or another production method deemed appropriate by those skilled in the art.

### DRAWINGS

Other advantages ensue from the following description of the drawings. The drawings show an exemplary embodiment of the invention. The drawings, the description, and the claims contain numerous features in combination. Those skilled in the art will also suitably consider the features individually and unit them in other meaningful combinations.

FIG. 1 shows a hand-held power tool equipped with a transmission device according to the invention,

FIG. 2 is a schematic side view of the transmission device with an overload clutch, and

FIG. 3 is a perspective view of a gear unit of the overload clutch.

### DESCRIPTION OF THE EXEMPLARY EMBODIMENT

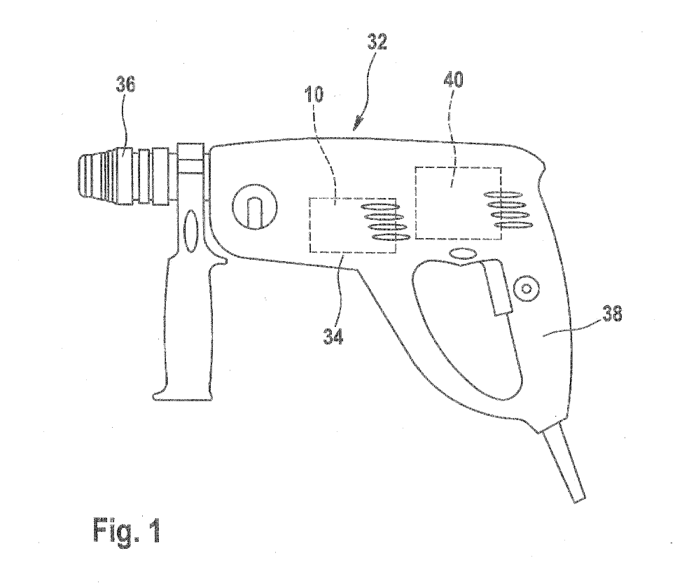

FIG. 1 shows a hand-held power tool 32 embodied in the form of a rotary hammer. The hand-held power tool 32 has a housing 34 and, in a front region, a tool holder 36 for holding a tool. At an end oriented away from the front region, the hand-held power tool 32 has a main handle 38 for actuating the hand-held power tool 32 and for transmitting force from an operator to the hand-held power tool 32.

The hand-held power tool 32 has a drive unit 40 for producing a drive moment. The drive torque of the drive unit 40 is transmitted via an intermediate shaft of the hand-held power tool 32 to a pneumatic impact mechanism, not shown in detail, and/or to a rotating output means 12 constituted by a hammer tube 42.

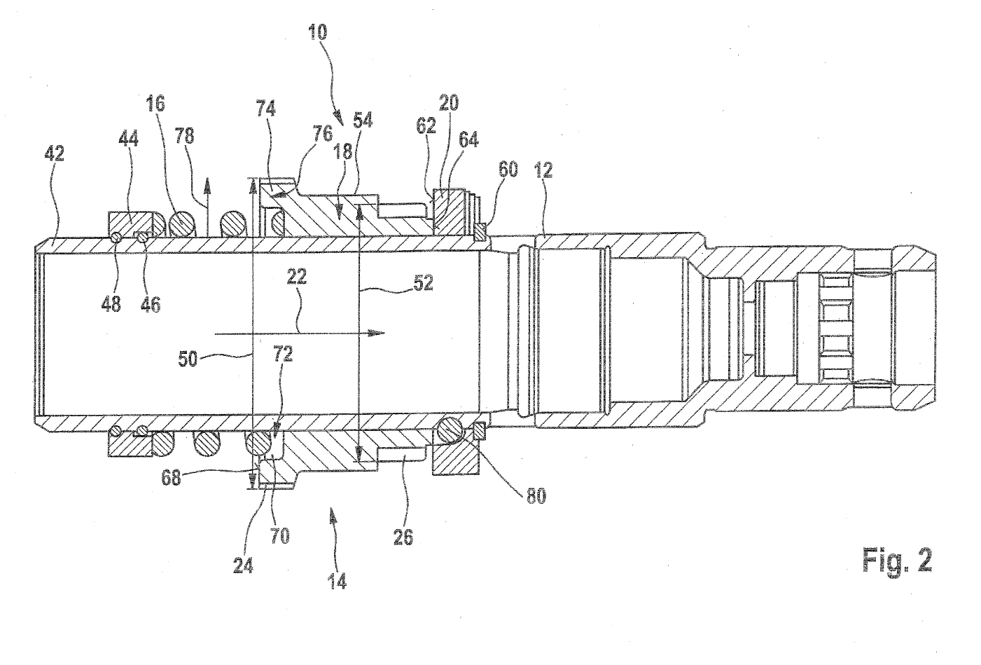

FIG. 2 shows a subregion of the hand-held power tool 32, with a transmission device 10. The transmission device 10 has an overload clutch 14 that is mounted on the hammer tube 42. The overload clutch 14 includes a gear unit 18 embodied in the form of a sintered component, a spring element embodied 16 in the form of a helical spring, and a detent element 20. The spring element 16, the gear unit 18, and the detent element 20 are situated on the hammer tube 42 in sequence with one another along a force flow direction 22 of the hammer tube 42. In order to support the spring element 16, a support element 44 embodied in the form of a support ring is situated before the spring element 16 along the force flow direction 22 and is affixed to the hammer tube 42 in the force flow direction 22 by means of two snap rings 46, 48 (FIG. 2). Fundamentally, however, it is also conceivable for the support element 44 or the spring element 16 to be fastened directly to the hammer tube 42 in the force flow direction 22.

In order to support the spring element 16 against the gear unit 18, the gear unit 18 is embodied in a step-like fashion at an end 68 oriented toward the spring element 16. A recess 70 embodied in step-like fashion for receiving the spring element 16 extends in the force flow direction 22 into a radially inner subregion 72 of the gear unit 18. A step-like cover 74 is situated in a radially outer subregion 76 of the gear unit 18 and covers the recess 70 in the direction opposite the force flow direction 22 so that the spring element 16 is secured in the gear unit 18 in the radial direction 78.

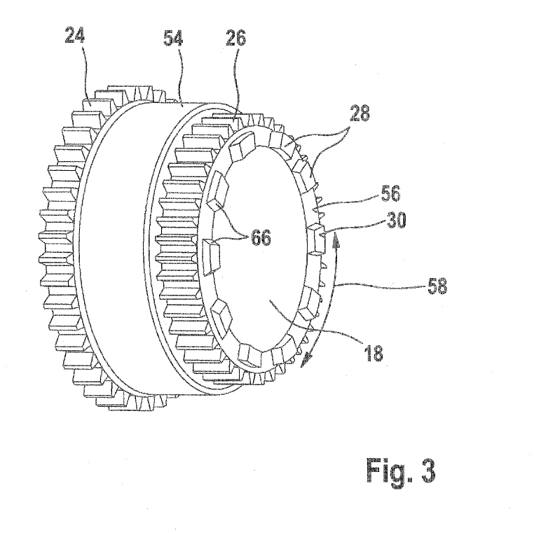

The gear unit 18 has two torque-transmitting regions 24, 26 that are provided to transmit different drive speeds to the hammer tube 42. The two torque-transmitting regions 24, 26 are each comprised of an external gearing that can be coupled to a corresponding gearing of a torque-transmitting means, not shown, of the transmission device 10 in order to transmit torque. The first torque-transmitting region 24 of the gear unit 18 has a working radius 50 that is larger than a working radius 52 of the second torque-transmitting region 26 so that the two torque-transmitting regions 24, 26 can be used to implement different torques and different drive speeds of the hammer tube 42 and of a tool coupled to the hammer tube 42 for co-rotation during operation of the hand-held power tool 32 and transmission device 10 (FIG. 2). Between the two torque-transmitting regions 24, 26 along the force flow direction 22, there is also a subregion 54 of the gear unit 18 that has a smooth contour without gearing (FIGS. 2 and 3).

For transmitting torque to the hammer tube 42, the gear unit 18 has a plurality of force-transmitting elements 28 of the overload clutch 14 (FIG. 3). The force-transmitting elements 28 are provided to couple with the detent element 20 of the overload clutch 14 and are situated on a surface 56 of the gear unit 18 facing in the force flow direction 22. The gear unit 18 and the force-transmitting elements 28 in this case are embodied of one piece with each other. The force-transmitting elements 28 have a trapezoidal transverse profile 30 and are arranged spaced uniformly apart from one another in a circumference direction 58 of the gear unit 18. In addition, the force-transmitting elements 28 extend in the force flow direction 22 in the form of extensions on the gear unit 18 (FIG. 3).

To transmit torque from the gear unit 18 via the detent element 20 to the hammer tube 42, the detent element 20 is coupled to the hammer tube 42 for co-rotation by means of a ball 80 and is affixed to the hammer tube 42 along the force flow direction 22 by means of a snap ring 60 (FIG. 2). In addition, on its side 62 oriented toward the gear unit 18, the detent element 20 has a transmitting contour, not shown in detail here, that corresponds to the gear unit 18 or more precisely to the force-transmitting elements 28 of the gear unit 18.

During operation of the hand-held power tool 32 and transmission device 10, the spring element 16 produces a coupling between the gear unit 18 or more precisely force-transmitting elements 28 and the detent element 20. A maximum torque that the hand-held power tool 32 is able to transmit via a tool mounted in the tool holder 36 to an item to be machined results from a cooperation of a spring force of the spring element 16 and an embodiment of the force-transmitting elements 28. The force-transmitting elements 28, which are situated on an end 64 of the gear unit 18 oriented toward the detent element 20, have a transmission flank 66 oriented in the circumference direction 58, which forms a step-like transition between the trapezoidal transverse profile 30 of a force-transmitting element 28 and the end 64 of the gear unit 18 oriented toward the detent element 20. The transmission flank 66 of the force-transmitting elements 28 has an oblique surface, which, in cooperation with the spring force of the spring element 16, determines a maximum torque to be transmitted.

If the torque to be transmitted during operation of the hand-held power tool 32 and transmission device 10 is less than a maximum torque that is transmittable by the overload clutch 14, then the force-transmitting elements 28 couple the gear unit 18 to the hammer tube 42 for co-rotation via the detent element 20. If the torque required to rotate the tool exceeds the maximum transmittable torque, then the overload clutch 14 disconnects the transmission of torque. In so doing, the gear unit 18 is slid on the hammer tube 42 counter to the spring force of the spring element 16, in the direction opposite from the force flow direction 22, and the force-transmitting elements 28 are pushed out from the transmission contour of the detent element 20. This disconnects a transmission of torque from the gear unit 18 to the detent element 22 and therefore to the hammer tube 42.

1-9. (canceled)

10. A transmission device, in particular for a rotary hammer and/or chisel hammer, comprising an output device and an overload clutch that is situated on the output device, the overload clutch being equipped with a spring element, a gear unit, and a detent element, with the spring element being situated on the output device before the gear unit and with the detent element being situated along a force flow direction of the output device.

11. The transmission device as recited in claim 10, wherein the gear unit is situated on the output device, before the detent element along the force flow direction of the output device.

12. The transmission device as recited in claim 10, wherein the gear unit has at least two torque-transmitting regions for transmitting different drive speeds to the output device.

13. The transmission device as recited in claim 11, wherein the gear unit has at least two torque-transmitting regions for transmitting different drive speeds to the output device.

14. The transmission device as recited in claim 10, wherein the gear unit has at least one force-transmitting element that is provided for coupling to the detent element.

15. The transmission device as recited in claim 11, wherein the gear unit has at least one force-transmitting element that is provided for coupling to the detent element.

16. The transmission device as recited in claim 12, wherein the gear unit has at least one force-transmitting element that is provided for coupling to the detent element.

17. The transmission device as recited in claim 13, wherein the gear unit has at least one force-transmitting element that is provided for coupling to the detent element.

18. The transmission device as recited in claim 14, wherein the gear unit and the force-transmitting element are at least partially of one piece with each other.

19. The transmission device as recited in claim 15, wherein the gear unit and the force-transmitting element are at least partially of one piece with each other.

20. The transmission device as recited in claim 16, wherein the gear unit and the force-transmitting element are at least partially of one piece with each other.

21. The transmission device as recited in claim 17, wherein the gear unit and the force-transmitting element are at least partially of one piece with each other.

22. The transmission device as recited in claim 14, wherein the force-transmitting element has a trapezoidal transverse profile.

23. The transmission device as recited in claim 15, wherein the force-transmitting element has a trapezoidal transverse profile.

24. The transmission device as recited in claim 18, wherein the force-transmitting element has a trapezoidal transverse profile.

25. The transmission device as recited in claim 19, wherein the force-transmitting element has a trapezoidal transverse profile.

26. The transmission device as recited in claim 10, wherein the detent element is coupled to the output device for co-rotation.

27. The transmission device as recited in claim 22, wherein the detent element is coupled to the output device for co-rotation.

28. The transmission device as recited in claim 10, wherein the gear unit is composed of a sintered component.

29. A hand-held power tool with a transmission device as recited in claim 10.
